(19) United States
(12) Patent Application Publication
(10) Pub. No.: US 2002/0133423 A1
(43) Pub. Date: Sep. 19, 2002

(54) Article management system, article mangement method, article management program, and computer-readable storage medium on which an article management program is stored

(76) Inventors: Rikio Shiba, Kanagawa (JP); Yukihiko Shimizu, Chiba (JP); Nobuhiro Andou, Chiba (JP); Kazuomi Kondo, Tokyo (JP)

Correspondence Address: FITZPATRICK CELLA HARPER & SCINTO, 30 ROCKEFELLER PLAZA, NEW YORK, NY, 10112, US

(21) Appl. No.: 10/093,931

(22) Filed: Mar. 11, 2002

(30) Foreign Application Priority Data
Mar. 12, 2001 (JP) 069404/2001

(51) Int. Cl. G06F 17/60

(52) U.S. Cl. 705/26

(57) ABSTRACT

In an article management system, an order for an article is issued from a terminal of a deliverer who delivers an article to a customer, and an incentive is given to a deliverer when the deliverer gets an order for an article from a customer. Information about the order reception, delivery, and incentive is managed so that a customer, a deliverer, and a seller can all obtain benefits in their business.

### BACKGROUND OF THE INVENTION

1. Field of the Invention

The present invention relates to an article management system, a server, a terminal, an article management method, an article management program, and a computer-readable storage medium on which an article management program is stored, which are advantageous for managing an article such as an expendable article for use with an apparatus such as an image forming apparatus.

2. Description of the Related Art

Conventionally, a user of an apparatus such as an image forming apparatus has to manage not only the main part of the apparatus but also an article such as an expendable article used with the main part of the apparatus.

In the case where the apparatus is an image forming apparatus, specific examples of articles used with the apparatus include a toner cartridge, ink, and paper.

When the apparatus has run out or short of some expendable article such as a toner cartridge, a user of the apparatus has to issue an order for the expendable article to a seller via a facsimile or a telephone or has to ask the seller to collect back the expendable article. On the other hand, the role of a sales driver is only to deliver an ordered article to a customer.

Thus, the user of the apparatus has to manage an article such as an expendable article. This is troublesome for the user.

Delivery of an article for use with an apparatus and collection of a used article (such as a used toner cartridge) are performed separately. Thus, the transportation cost arises twice, that is, when a seller delivers an article such as a toner cartridge to a customer and when the seller collects a used article from the customer. Another problem is that customers have to spend time to order articles.

Another problem in the conventional system is that if a seller wants to promote sales, the seller has to employ additional sales persons for sales promotion.

### SUMMARY OF THE INVENTION

In view of the above, it is an object of the present invention to provide an article management system, an article management method, an article management program, and a computer-readable storage medium on which an article management program is stored, which are advantageous for customers, deliverers, and sellers, in particular when an article is sold.

It is another object of the present invention to provide an article management system, an article management method, an article management program, and a computer-readable storage medium on which an article management program is stored, which ease a task performed by a customer to manage an article and which make it possible to transport an article in a highly efficient manner when the article is sold or collected.

In order to achieve the above objects, the present invention provides an article management system comprising order reception means for receiving an order from a terminal of a deliverer who delivers an article to a customer, and management means for managing an incentive given to the deliverer in accordance with an order received via the order reception means.

Further objects, features and advantages of the present invention will become apparent from the following description of the preferred embodiments with reference to the attached drawings.

### BRIEF DESCRIPTION OF THE DRAWINGS

FIG. 1 is a diagram generally illustrating an article management system according to an embodiment of the present invention.

FIG. 2 is a block diagram illustrating the internal construction of an order reception management server used in the article management system according to the embodiment of the present invention.

FIG. 3 is a table illustrating an example of data managed by a database stored in the order reception management server shown in FIG. 1.

FIG. 4 is a diagram conceptually illustrating business relationships in the article management system shown in FIG. 1.

FIG. 5 is a diagram illustrating a general operation performed in the article management system shown in FIG. 1.

FIG. 6 is a flow chart illustrating an operation performed, in the article management system shown in FIG. 1, by a sales driver to acquire customer information and send a mail to a customer thereby providing information to the customer.

FIG. 7 is a diagram illustrating a screen that is displayed on a handy terminal of a sales driver when customer/delivery information is transmitted to the handy terminal of the sales driver, in the article management system shown in FIG. 1.

FIG. 8 is a diagram illustrating a screen that is displayed on a handy terminal of a sales driver in response to a request, issued by a sales driver, for detailed customer information, in the article management system shown in FIG. 1.

FIG. 9 is a diagram illustrating an example of a screen that is displayed on a handy terminal when a column of cartridge type shown in FIG. 8 is clicked.

FIG. 10 is a diagram illustrating an example of a screen that is displayed on a handy terminal when a column of cartridge type shown in FIG. 8 is clicked.

FIGS. 11A and 11B are diagrams illustrating examples of screens that are displayed on a handy terminal when a sales driver sends an E-mail to particular customers who satisfy a predetermined condition, in the article management system shown in FIG. 1.

FIG. 12 is a diagram illustrating an example of a mail that is transmitted to a client device of a customer from an order reception management server in response to a mail transmission command issued by a sales driver.

FIG. 13 is a flow chart illustrating a sequence of steps of a mail information confirmation/transmission operation, in the article management system shown in FIG. 1.

FIG. 14 is a diagram illustrating an example of a custom information registration/change screen transmitted to a handy terminal, in the article management system shown in FIG. 1.

FIG. 15 is a flow chart illustrating an article selling operation performed in the article management system shown in FIG. 1.

FIG. 16 is a diagram illustrating an example of an order confirmation screen that is displayed on a handy terminal of a sales driver in accordance with data transmitted from an order reception management server, in a selling operation performed in the article management system shown in FIG. 1.

FIG. 17 is a flow chart illustrating a sequence of steps of a selling operation performed in the article management system shown in FIG. 1.

FIG. 18 is a flow chart illustrating a stock management operation performed in the article management system shown in FIG. 1.

FIG. 19 is a flow chart illustrating a collection operation performed in the article management system shown in FIG. 1.

FIG. 20 is a flow chart illustrating an operation performed by the order reception management server to determine a predicted number of articles to be collected, in the article management system shown in FIG. 1.

FIG. 21 is a diagram illustrating an example of a collection confirmation screen that is displayed on a handy terminal of a sales driver in accordance with data transmitted from the order reception management server during a collection operation, in the article management system shown in FIG. 1.

FIG. 22 is a flow chart illustrating a sequence of steps of a collection operation performed in the article management system shown in FIG. 1.

FIG. 23 is a diagram illustrating incentive information associated with each sales driver, managed by the order reception management server shown in FIG. 1.

### DESCRIPTION OF THE PREFERRED EMBODIMENTS

The present invention is described in further detail below with reference to preferred embodiments in conjunction with the accompanying drawings. Note that the present invention is not limited to specific sizes, materials, shapes, layouts, and the like of constituent parts employed in the embodiments described below, unless specified otherwise.

In the drawings referred to in the following description, similar parts are denoted by similar reference numerals. Note that the following description of the article management system according to preferred embodiments of the present invention includes descriptions of a server, a terminal, an article management method, an article management program, and a computer-readable storage medium on which an article management program is stored.

General Construction

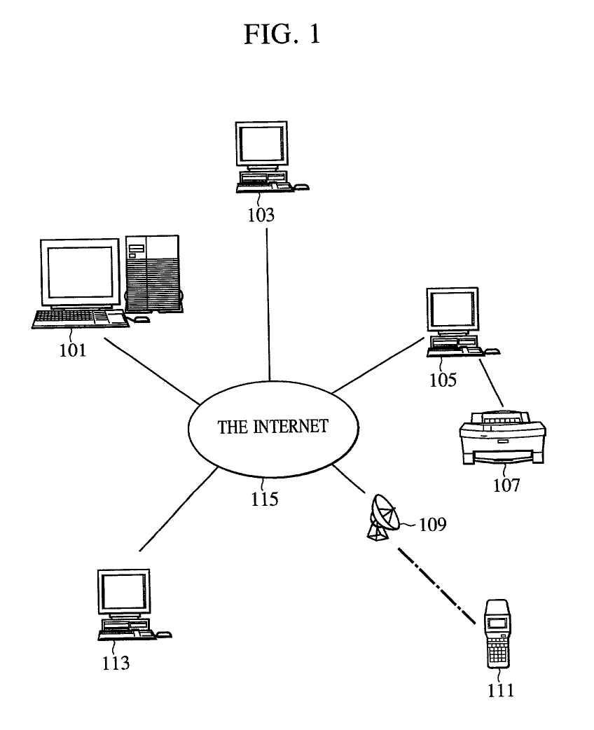

The general construction of an article management system according to an embodiment of the present invention is described below with reference to FIGS. 1 to 5. In this article management system according to the present embodiment of the invention, it is assumed that an article for use with an image forming apparatus is managed by the article management system.

In the article management system according to the present embodiment of the invention, the image forming apparatus used in conjunction with the article may be a printer, a facsimile, or a copy machine.

The image forming apparatus includes image forming means. The image forming means may be based on electrophotography, ink-jet image formation technology, or bubble-jet image formation technology. The image forming means is not limited to those types, but the image forming means may be based on thermal transfer image formation technology, thermal image formation technology, or other image formation technologies other than impact image formation technology such as wire dot image formation technology.

FIG. 1 illustrates the entire structure of an article management system according to an embodiment of the present invention. As shown in FIG. 1, the article management system according to the present embodiment of the invention includes a management server 101 that stores various kinds of data needed to manage articles, and supplies data to another server or a client device, and the article management system also includes an article supplier server 103 of a supplier of articles, such as a toner cartridge used with an image forming apparatus. The article management system further includes an article deliverer terminal 105 used by a deliverer who delivers the article and a printer 107 connected to the article deliverer terminal 105. The article management system further includes a handy terminal 111 serving as a radio terminal used by an article deliverer, and a radio base station 109 for connecting the handy terminal 111 to a network such as the Internet 115. The article management system further includes a client device 113 used by a customer who orders and uses an article.

The order reception management server 101, the article supplier server 103, the article deliverer terminal 105, the radio base station 109, and the client device 113 are connected to each other via the Internet 115. The Internet 115 may be constructed of either a wireless communication line or a cable communication line or may be constructed of a combination of a wireless communication line and a cable communication line.

Although in the specific example shown in FIG. 1, the article management system according to the present invention includes one order reception management server 101, one article supplier server 103, one article deliverer terminal 105, one radio base station 109, and one client device 113, the number of each type of servers/terminals is not limited to one, but the article management system may include two or more servers or terminals for each type.

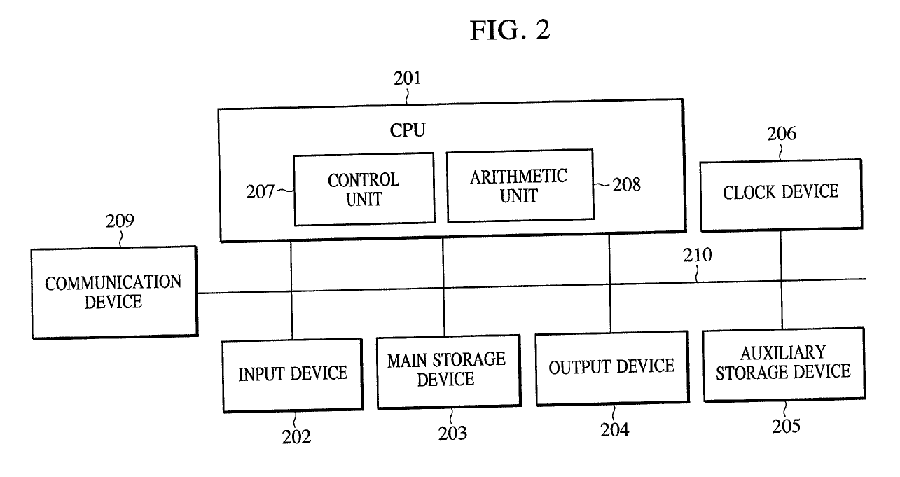

The internal construction of the order reception management server 101 shown in FIG. 1 is described below with reference to FIG. 2 that illustrates, in the form of a block diagram, the internal construction of the order reception management server 101 used in the article management system according to the present embodiment shown in FIG. 1. As shown in FIG. 2, the order reception management server includes a CPU (Central Processing Unit) 201, an input device 202, a main storage device 203, an output device 204, an auxiliary storage device 205, a clock device 206, and a communication device 209. The CPU 201 is also called a processor and includes a control unit 207 for transmitting a command to various parts in the system to control them and also includes an arithmetic unit 208 that is a central device of the server and that performs an arithmetic or logical operation on digital data. In the present invention, the CPU 201 operates in cooperation with a program stored in the main storage device 203 or the auxiliary storage device 205 so as to serve as one or all of storage means for storing information indicating the number of articles in stock or the number of collected articles, calculation means for calculating the number of articles in stock or the number of collected articles, updating means for updating a sales point or a collection point, and means for calculating the mean time between purchase. The CPU 201 may also serve as one or all of order reception means for receiving an order for an article from a terminal carried by a deliverer who delivers the article to a customer, management means for managing an incentive given to a deliverer in accordance with an order received by the order reception means, and notification means for, before delivering an article to a customer, sending a message to the customer to prompt the customer to order the article.

The handy terminal 111 has an internal construction similar to that shown in the block diagram of FIG. 2. In this case, the CPU 201 operates in cooperation with the output device 204, the communication device 209, and a program stored in the main storage device 203 or the auxiliary storage device 205 so as to serve as constituent components of the present invention, such as receiving means, display means, acceptance means, transmission means, and information output means.

In accordance with a timing clock signal generated by the clock device 206, the control unit 207 stores data input via the input device 202 and data indicating a predetermined procedure (such as a program or software) into the main storage device 203, and the control unit 207 sends a command in accordance with the data or program stored in the main storage device 203 to the arithmetic unit 208, which performs an arithmetic or logical operation in response to the received command. The result of the arithmetic or logical operation is transmitted, under the control of the control unit 207, to an internal or external device such as the main storage device 203, the output device 204, and the auxiliary device 205.

The input device 202 is used to input various kinds of data. Specific examples of the input device 202 include a keyboard a mouse, a pointing device, a touch panel, a mouse pad, a CCD camera, a card reader, a paper tape reader and a magnetic tape drive.

The main storage device 203 is also called a memory and is capable of pointing to any addressable storage space in internal storage devices and processing devices during execution of a command. The main storage device 203 is formed mainly of a semiconductor memory device. The main storage device 203 is used to store a program or data input, and data stored in the main storage device 203 is read into, for example, a register under the control of the control unit 207. Specific examples of the semiconductor memory device used as the main storage device 203 include a RAM (Random Access Memory) and a ROM (Read Only Memory).

The output device 204 is used to output the result of the arithmetic or logical operation or the like performed by the arithmetic unit 208. Specific examples of devices usable as the output device 204 include a display such as a CRT, a plasma display panel, and a liquid crystal display, a printing device such as a printer, and an audio output device.

The auxiliary storage device 205 is used to supplement the storage capacity of the main storage device 203. Various kinds of disk drives may be used as the auxiliary storage device 205. Specific examples are disk drives using a magnetic disk, an optical disk, a semiconductor disk, a floppy disk, a hard disk, a CD-ROM disk, a CD-R disk, a CD-RW disk, a DVD-ROM disk, a DVD-R disk, a DVD+RW disk, a DVD−RW disk, a DVD-RAM disk, or a MO disk.

The communication device 209 is used to communicate with an external device via a network. The communication device 209 transmits and receives data via the network connected to the communication device 209 and performs a conversion between digital and analog forms as required.

The above-described devices are connected to each other via an address bus or a data bus 210.

Although in this specific example, a single main storage device 203 and a single auxiliary storage device 205 are used, as many main storage devices and auxiliary storage devices as needed may be used. If the number of main storage devices and/or auxiliary storage devices is increased, the server has higher resistance against failures.

In the present invention, various programs used by the server to execute a process are stored in at least one of the main storage device 203 and the auxiliary storage device 205. Thus, in the present invention, the computer-readable storage medium for storing a program used by the server to execute a process may be realized by at least one of the main storage device 203 and the auxiliary storage device 205. The computer-readable storage media according to the present embodiment of the invention include a storage medium readable by a server and a storage medium readable by a terminal.

The program used in the system according to the present invention may include a program for controlling a computer (terminal), a program for controlling a server, and program for controlling a database or any combination of such programs. The program may also be a program for controlling all such devices. In the present invention, the computer-readable storage medium on which the program is stored may be a single storage medium that is disposed on one device, wherein the program may include all steps of controlling the whole process performed in the system. Alternatively, a part of the full set of steps may be stored on a storage medium disposed on some device in the system so that the total system can correctly function.

The auxiliary storage device 205 shown in FIG. 2 is also used to store a database in which various kinds of information are described. The term “database” is usually used to describe a collection of information (data). However, in the present invention, the term “database” is used to describe not only such a collection of information but also a physical storage medium or storage device such as a hard disk, a magnetic storage medium, or an optical storage medium such as an optical disk on which a collection of information is stored. Thus, the database in the order reception management server serves as storage means that is one of constituent elements of the present invention. Not only the auxiliary storage device 205 but also a database server connected to the server may be used to establish the database.

Note that databases are distinguished from each other not by physical storage media on which they are stored but by information stored therein. This means that a plurality of databases each including a collection of information may all be established on a single storage disk, such as magnetic disk or a single optical disk. Conversely, a single database may include a collection of information stored over a plurality magnetic disks or optical disks.

Although the internal construction has been described above only for the order reception management server 101 shown in FIG. 1, other devices in FIG. 1 such as the article supplier server 103, the article deliverer terminal 105, the radio base station 109, and the client 113 may have a similar internal construction to that shown in FIG. 2 and may operate in a similar manner.

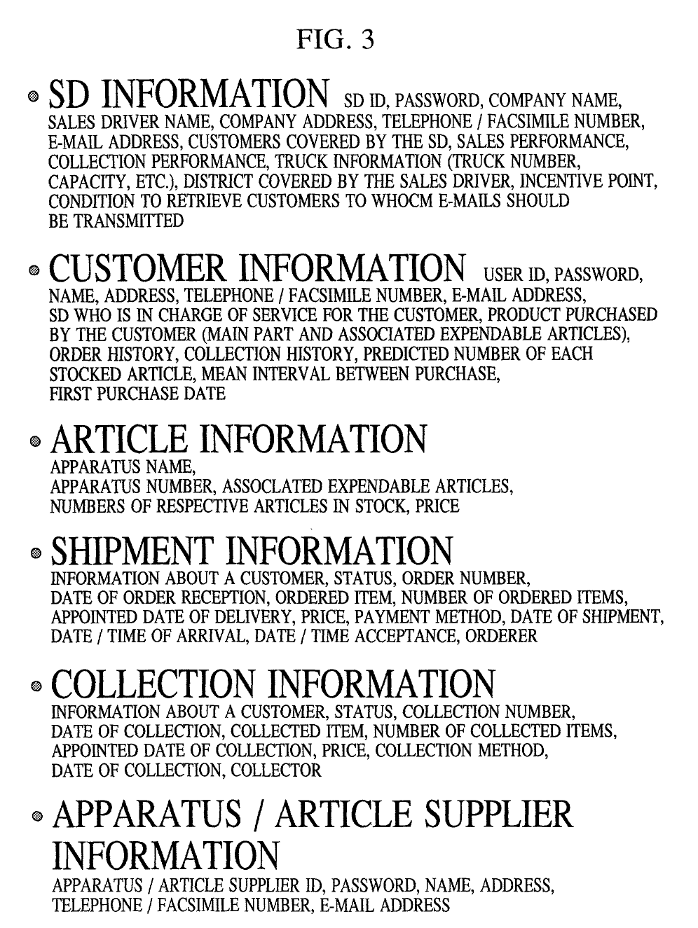

An example of data being managed by the database in the order reception management server 101 shown in FIG. 1 is described below with reference to FIG. 3 that illustrates, in the form of a table, an example of data managed by the database in the order reception management server 101 shown in FIG. 1.

As shown in FIG. 3, the information described in the database in the order reception management server 101 include SD information associated with a sales driver (SD) who deliveries an article and customer information associated with a customer who uses an article.

The database in the order reception management server 101 further include article information associated with an article, shipment information indicating a status associated with the shipment of an article, collection information associated with the collection of an article, and article supplier information associated with a supplier of an article.

The SD information includes information about an SD ID, a password, a company name, a sales driver name, a company address, a telephone/facsimile number, an E-mail address, customers covered by the sales driver, a sales performance, a collection performance, a truck information (truck number, capacity, etc.), information indicating a district covered by the sales driver, an incentive point (such as a sales point or a collection point that will be described later), and a customer retrieval condition for retrieving particular customers to which an E-mail should be transmitted.

The customer information includes information about a customer ID, a password, a name, an address, a telephone/facsimile number, an E-mail address, information associated with a SD in charge of the customer, the name of a product purchased by the customer (a main part and an expendable part), a history of received orders, a history of collection, the predicted number of stocked articles for each item, the mean period between purchase, and the first purchase date/time at which an article was first purchased.

The article information includes information about the name of an apparatus that uses an article, an apparatus number, articles used with the apparatus, the number of articles in stock for each item, and prices.

The shipment information includes information about a customer to which an article is shipped, a status, an order number, an order date, the item of ordered articles, the number of ordered articles, the appointed date of delivery, a price, a payment method, a shipment date/time, a date/time of arrival of articles, a date of acceptance of articles, and an order issuer.

The collection information includes information about a customer from whom an article is collected, a status, a collection number, a collection date/time, an item of articles to be collected, the number of articles to be collected, an appointed date/time of collection, a price, a collection method, a scheduled date/time of collection, and a collector name.

The article supplier information includes information about an article supplier ID, a password, a name, an address, a telephone/facsimile number, and an electronic mail address.

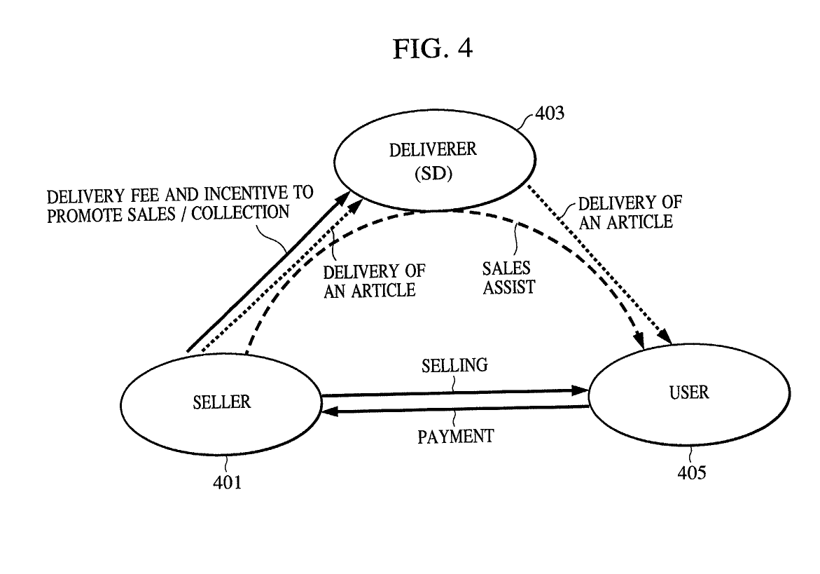

Business relationships in the article management system shown in FIG. 1 are described below with reference to FIG. 4. FIG. 4 is a diagram conceptually illustrating business contracts made in the article management system shown in FIG. 1.

As shown in FIG. 4, the article management system according to the present invention includes a seller 401 who sells an article, a deliverer 403 such as a delivery company, and a customer 405 who uses the article. In FIG. 4, the deliverer 403 is denoted by “SD” that stands for a “sales driver”. The sales driver is not necessarily a deliverer who delivers an article supplied by an article supplier to a customer, but the sales driver may be any person who has contracts shown in FIG. 4 with an article supplier and with a deliverer or a delivery company. The relationship between the seller 401 and the deliverer 403 is such that the seller 401 provides an article to a customer via the deliverer 403, and the seller 401 pays not only a delivery fee to the deliverer 403 but also gives an incentive to the deliverer 403 to promote the sales and collection. The relationship between the deliverer 403 and the customer 405 is such that the deliverer 403 delivers an article to the customer 405. The relationship between the seller 401 and the customer 405 is such that the seller 401 sells an article to the customer 405, and the customer 405 pays a price for the article to the seller 401. The deliverer 403 assists the seller 401 in selling an article.

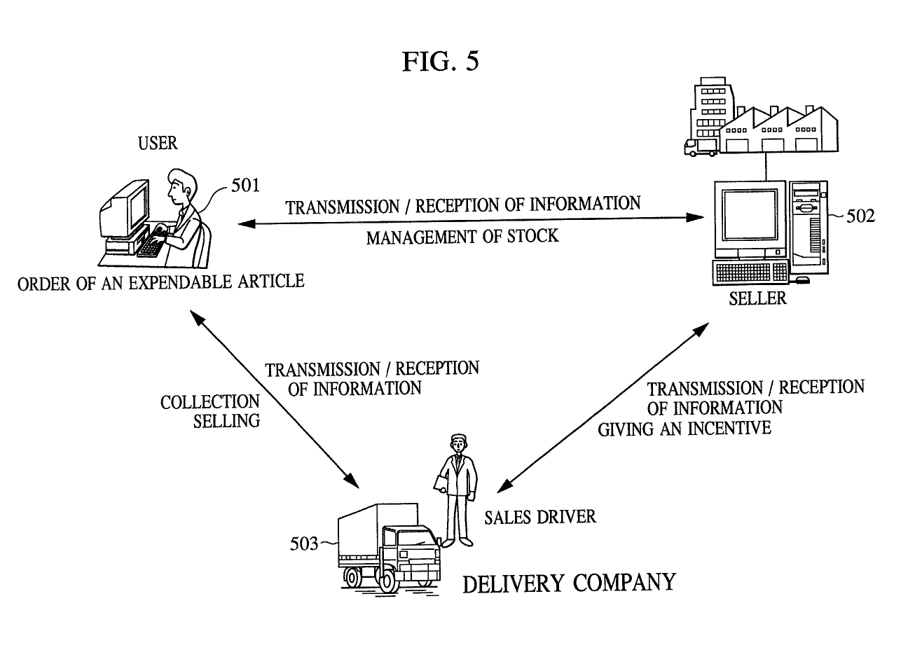

The outline of the total operation of the article management-system shown in FIG. 1 is further described below with reference to FIG. 5 that illustrates the total operation of the article management system shown in FIG. 1.

As shown in FIG. 5, the customer 501 and the seller 502 communicate with each other, and the seller 502 manages the number of articles stocked by the customer 501. The seller 502 and the sales driver (SD) 503 of the delivery company communicate with each other, and the seller 502 gives an incentive to the sales driver 503. The sales driver 503 and the customer 501 communicate with each other, and the sales driver 503 delivers and collects an article to and from the customer 501.

Customer Information Confirmation and Mail Transmission

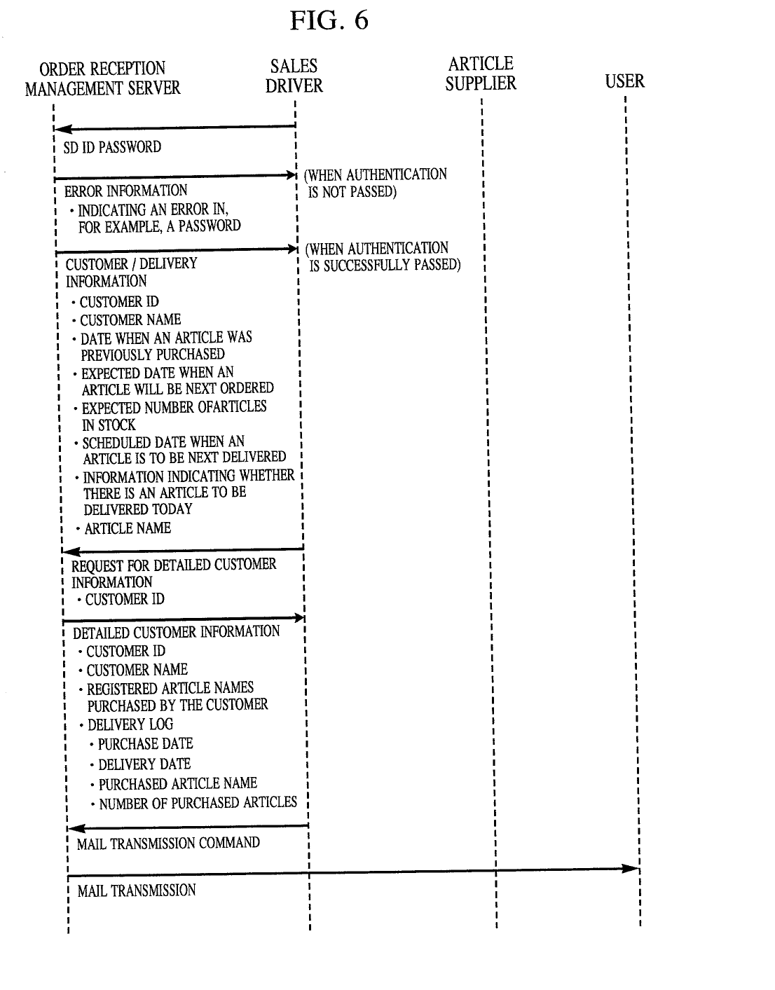

An operation performed, in the article management system shown in FIG. 1, by a sales driver to acquire customer information and send a mail to a customer is described below with reference to FIGS. 6 to 11.

FIG. 6 is a flow chart illustrating an operation performed by a sales driver to acquire customer information and send a mail to the customer to provide information to the customer.

As shown in FIG. 6, in order to acquire customer information, the sales driver inputs his/her ID (SD ID) and password via the handy terminal 111 to get access to the order reception management server. This accessing operation is performed as a request transmission that is one part of the present invention. In the case where the order reception management server fails to authenticate the sales driver, the order reception management server transmits error information indicating that there is an error in, for example, the password, to the handy terminal of the sales driver. If the order reception management server succeeds in authentication of the sales driver, the order reception management server transmits customer/delivery information to the handy terminal of the sales driver. The customer/delivery information includes information about a customer ID, a customer name, a date when an article was previously purchased by the customer, an expected date when an article will be next purchased by the customer, an expected number of articles stocked by the customer, a scheduled date when an article is to be next delivered to the customer, information indicating whether there is an article to be delivered on the present day, and an article name.

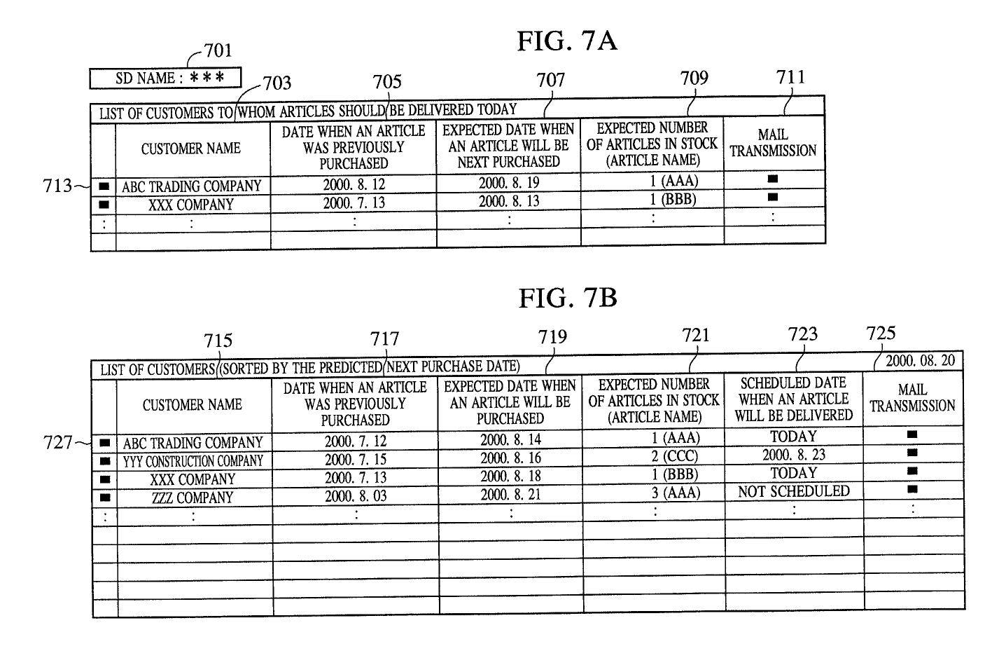

An example of a screen that is displayed on the handy terminal of the sales driver in response to reception of the customer/delivery information is described below with reference to FIG. 7. FIG. 7 illustrates an example of a screen that is displayed on the handy terminal of the sales driver when customer/delivery information is transmitted to the handy terminal of the sales driver in the article management system shown in FIG. 1. That is, in response to a request for customer/delivery information from the handy terminal, a list of customers to whom articles should be delivered on the present day such as that shown in FIG. 7A or a customer list such as that shown in FIG. 7B is displayed on the handy terminal.

As shown in FIG. 7A, the list of customers to whom articles should be delivered on the present day includes information about a sales driver name 701, a customer name 703, a previous purchase date 705, a predicted next purchase date 707, an article name and the number of articles stocked by a customer 709, a mail transmission button 711, and a detailed information button 713, wherein, in the present invention, the article name and the number of articles in stock are displayed for each customer.

On the other hand, the customer list shown in FIG. 7B includes entries associated with a customer name 715, a previous purchase date 717, a predicted next purchase date 719, an article name and a predicted number of articles stocked by a customer 721, a scheduled delivery date 723, a mail transmission button 725, and a detailed information button 727. The detailed information button 713 or 727 is used to display detailed information for each customer. Although in the above examples shown in FIGS. 7A and 7B, the number of articles in stock 709 and the article name 721 are displayed in the same column, they may be displayed in different columns.

As shown in the flow chart of FIG. 6, when the sales driver receives customer/delivery information, if the sales driver issues a request for detailed customer information on the basis of customer IDs, the order reception management server transmits the detailed customer information to the handy terminal of the sales driver. The detailed customer information includes a purchase/delivery log including entries associated with a customer ID, a customer name, a registered article name purchased by the customer, a purchase date, a delivery date, a purchased article name, and the number of articles purchased.

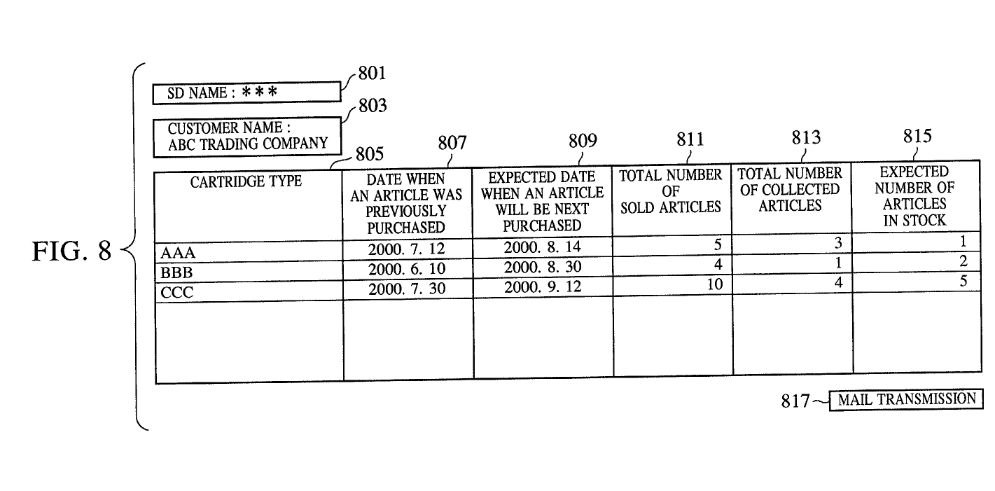

An example of a screen that is displayed on the handy terminal of the sales driver in response to a request for detailed customer information issued by the sales driver is described below with reference to FIG. 8. FIG. 8 illustrates an example of a screen that is displayed on the handy terminal of the sales driver, in the article management system shown in FIG. 1, in response to a request for detailed customer information issued by the sales driver. In this specific example, as can be seen from FIG. 8, it is assumed that an article that is delivered by the sales driver is a toner cartridge used with an image forming apparatus.

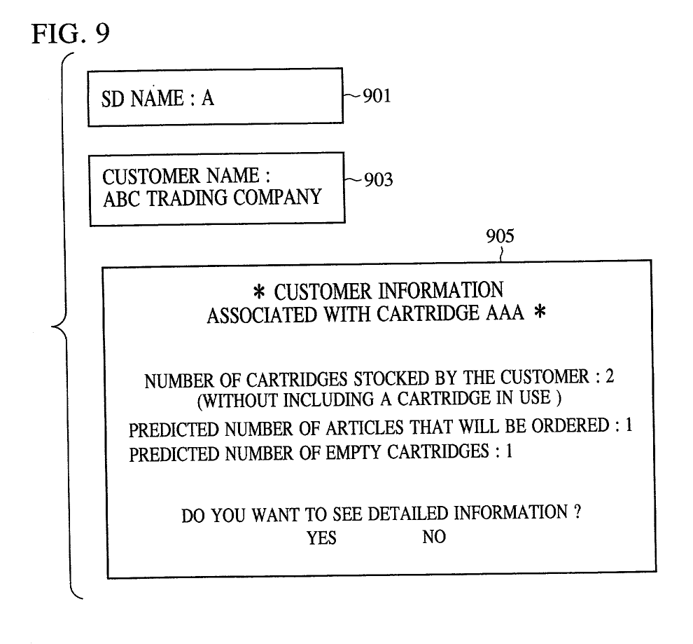

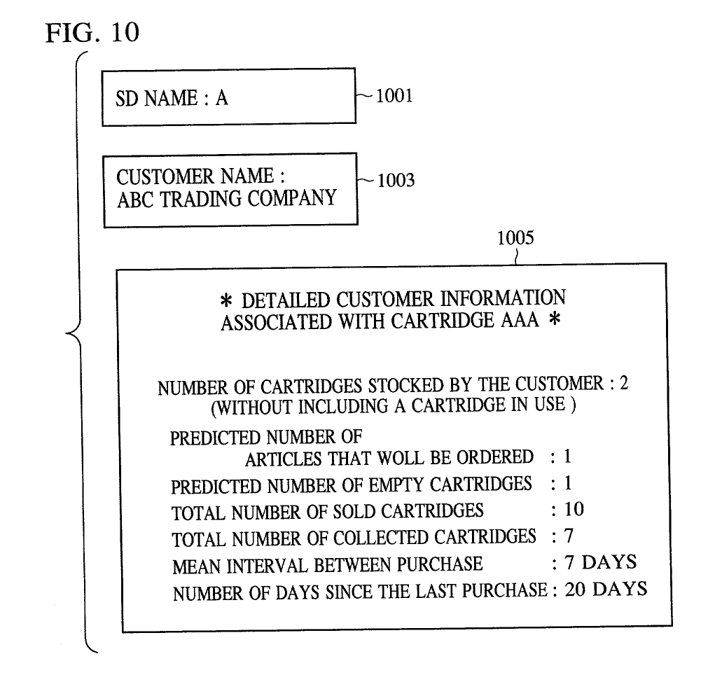

As shown in FIG. 8, information displayed on the handy terminal includes information about a sales driver name 801, a customer name 803, a cartridge type 805, a previous purchase date 807, a predicted next purchase date 809, a total number of sold articles 811, a total number of collected articles 813, and a predicted number of articles in stock 815. A mail transmission button 817 is displayed on the screen of the handy terminal. When the mail transmission button 817 is clicked, a mail is transmitted to a customer, as will be described later. In FIG. 8, if the column of cartridge type is clicked, more detailed information is displayed on the handy terminal as shown in FIGS. 9 or 10. That is, FIGS. 9 and 10 show examples of screens that are displayed when the column of cartridge type shown in FIG. 8 is clicked.

Information displayed on the screen shown in FIG. 9 includes information about a sales driver name (A) 901, a customer name (ABC Trading Company) 903, and customer information associated with a cartridge (AAA) 905. The customer information 905 includes information about the number of articles stocked by the customer, the number of articles predicted to be ordered, the predicted number of empty cartridges (CRG), and a message prompting the customer to determine whether to display more detailed information. If the sales driver clicks a “YES” button shown in FIG. 9 to issue a request for detailed information, the screen shown in FIG. 9 is switched to the screen shown in FIG. 10. Information displayed on the screen shown in FIG. 10, as with the screen shown in FIG. 9, includes information about a sales driver name (A) 1001, a customer name (ABC Trading Company) 1003, and detailed customer information associated with a cartridge (AAA) 1005. The detailed customer information includes information about the number of articles stocked by the customer, the number of articles predicted to be ordered, and the predicted number of empty cartridges (CRG).

As shown in FIG. 10, the detailed customer information further includes information about the total number of sold articles, the total number of collected articles, the mean time between purchase, and the number of days that have elapsed since the last purchase date. The mean time between purchase is calculated by the order reception management server 101, for example, by dividing the total period during which a particular number of articles have been sold to a particular customer by the particular number of articles. Of course, the mean time between purchases may be calculated in accordance with another formula or in another manner. Even in the case where used articles are not collected, the information about the mean time between purchase allows the sales driver to predict the need of the customer in terms of articles, and thus it becomes possible to promote sales.

The information, shown in FIG. 10, about the number of articles stocked by the customer, the number of articles predicted to be ordered, the predicted number of empty cartridges (CRG), the total number of sold articles, the total number of collected articles, the mean time between purchase, and the number of days that have elapsed since the last purchase date, forms information about the number of stocked articles for each customer according to the present invention or information about the number of collected articles for each customer according to the present invention.

Thereafter, as shown in the flow chart of FIG. 6, the sales driver requests the order reception management server to transmit a mail. The mail is transmitted to promote sales of articles to a customer or to inform the customer that the sales driver is going to visit the customer.

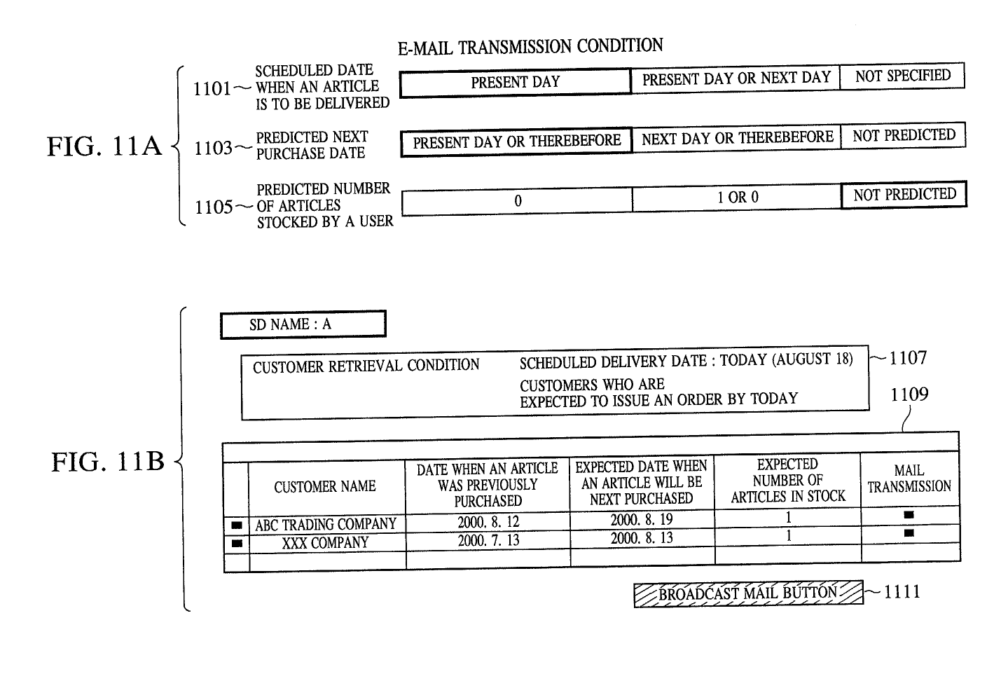

Particular customers to whom a mail should be sent may also be extracted by means of retrieval performed in accordance with a predetermined retrieval condition. For example, customers to whom a sales driver is going to deliver an article on the present day and who is expected to purchase an article by the present day may be extracted. As a result of the retrieval, particular customers who satisfy the predetermined condition are extracted and displayed as shown in FIG. 11B, and the mail described above is transmitted to the extracted customers. That is, FIG. 11 illustrates an example of a screen that is displayed on the handy terminal, in the article management system shown in FIG. 1, to allow the sales driver to transmit an E-mail only to customers who meet the predetermined condition.

As in the specific example shown in FIG. 11A, via the screen for setting a condition for extracting a customer to whom an E-mail should be transmitted, a scheduled delivery date 1101, a predicted purchase date 1103, and a predicted number of articles stocked by a customer 1105 are input to set the retrieval condition. Note that, in the article management system according to the present invention, the condition for retrieving customers to which an E-mail should be transmitted is not limited to that shown in FIG. 11A, but the condition may be specified in a different manner. For example, a customer may be extracted on the basis of only one of the scheduled delivery date 1101, the predicted purchase date 1103, and the predicted number of stocked articles 1105 so that a greater number of customers will be extracted. Some item in the retrieval condition may be deleted. Conversely, a new item may be added to the retrieval condition. The information indicating extracted customers, displayed on the screen, allows the sales driver to transmit an E-mail to proper customers who meet the condition simply by issuing an E-main transmission command. More specifically, when the sales driver acquires, via the customer list 1109 in the E-mail transmission screen shown in FIG. 11B, information indicating customers who meet the predetermined customer extraction condition 1107, if the sales driver clicks the “Broadcast Mail” button 1111, E-mails are simultaneously transmitted to all extracted customers.

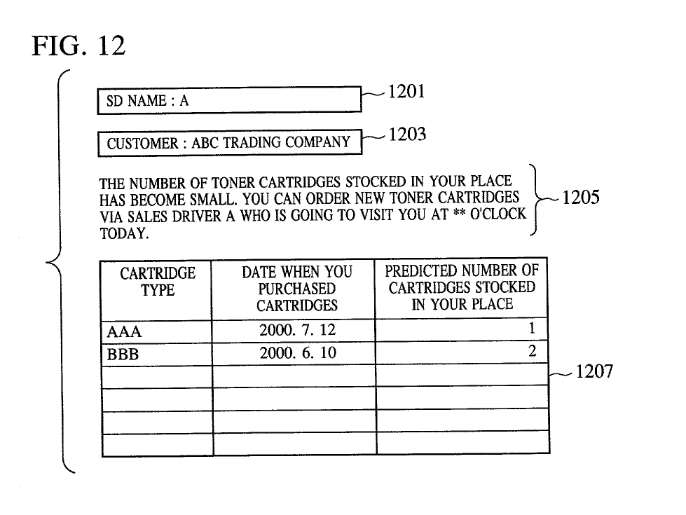

An example of a mail transmitted to a customer is described below with reference to FIG. 12. FIG. 12 illustrates an example of a mail that is transmitted from the order reception management server in the article management system shown in FIG. 1 to a client device of a customer in response to a mail transmission command issued by the sales driver.

As shown in FIG. 12, information displayed on the screen of the client device of the customer includes information about a sales driver name 1201, a customer name 1203, a message 1205, and a table 1207. The mail may be transmitted such that the content shown in FIG. 12 is included in the body of the mail or such that a file in which the content shown in FIG. 12 is described may be attached to the mail. On a date proximate a next purchase date predicted on the basis of the number of stocked articles, the previous purchase date, and the number of collected articles, the sales driver may transmit a mail to a customer. A mail may be transmitted to a customer who meets a predetermined condition, as described above with reference to FIG. 11.

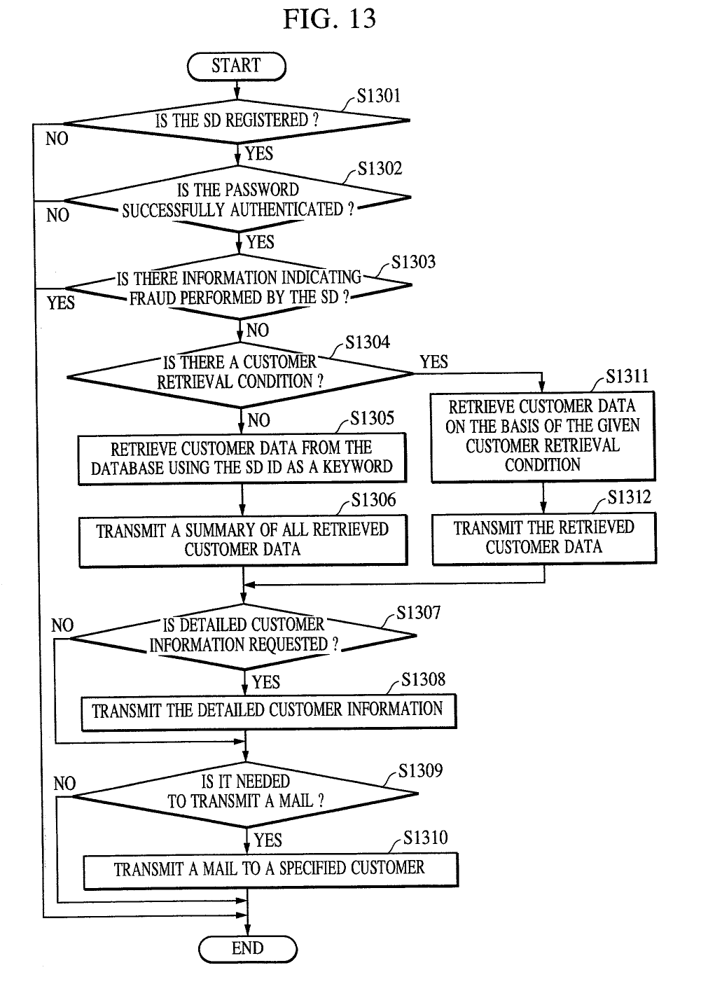

A sequence of steps of the mail information confirmation and mail transmission operation is described below with reference to FIG. 13. FIG. 13 is a flow chart illustrating the sequence of steps of the mail information confirmation/transmission operation performed in the article management system shown in FIG. 1.

First, in step S1301, the order reception management server determines, on the basis of a received SD ID, whether a sales driver is an authorized sales driver. If the sales driver is determined to be an authorized one, the process proceeds to step S1302. However, if the sales driver is not an authorized one, the process is terminated. Then, in step S1302, on the basis of the received SD ID and password, the order reception management server authenticates the password. If the authentication of the password is successful, the process proceeds to step S1303. However, if the authentication fails, the process is terminated.

In step S1303, the order reception management server determines whether there is information indicating fraud performed by the authorized sales driver (SD). If fraud is detected, the process is terminated. In the case where no fraud is detected, the process proceeds to step S1304.

In step S1034, the order reception management server determines whether a customer retrieval condition (for extracting customers to which an E-mail should be transmitted) such as that shown in FIG. 11 is specified. If the customer retrieval condition is specified (if the answer of step 1304 is “yes”), the process proceeds to step S1311. However, if the customer retrieval condition is not specified, the process proceeds to step S1305. In step S1311, the order reception management server retrieves customers according to the customer retrieval condition. Flow then proceeds to step S1312, where the order reception management server transmits the retrieved customer data to the handy terminal. Thereafter, the process proceeds to step S1307. On the other hand, if it is determined in step S1304 that no customer retrieval condition is specified, the process proceeds to step S1305.

In step S1305, on the basis of the ID of the sales driver, the order reception management server retrieves customers from the database. In step S1306, the order reception management server transmits a simplified version of customer data including all customers covered by the sales driver to his/her handy terminal. This simplified version of customer data corresponds to customer/delivery information described above with reference to FIGS. 6 and 7. Thereafter, the process proceeds to step S1307.

In step S1307, the order reception management server determines whether a request for detailed customer information has been received from the handy terminal. If it is determined that the request has been received, the order reception management server transmits the detailed customer information to the handy terminal (step S1308). However, if such a request is not received, the process proceeds to step S1309. The detailed customer information corresponds to the detailed customer information described earlier with reference to FIGS. 6, 8, 9, and 10.

In step S1309, the order reception management server determines whether a mail should be transmitted to a client device of a customer in response to a mail transmission request issued by the handy terminal. If it is determined that no mail transmission request is issued, the process ends. However, if it is determined that the mail should be transmitted, the process ends after transmitting the mail to the specified client device of the customer (step S1310). The content of the mail may be similar to that shown in FIG. 12. The mail transmission request may be issued, for example, when the “Broadcast Mail” button 1111 shown in FIG. 11B is clicked. In response to clicking the “Broadcast Mail” button 1111, mails may be simultaneously transmitted to all retrieved customers who meet the predetermined condition.

Although not described above, the mail information confirmation/transmission operation may include a step of addition of new customer information and/or a step of a change in existing customer information.

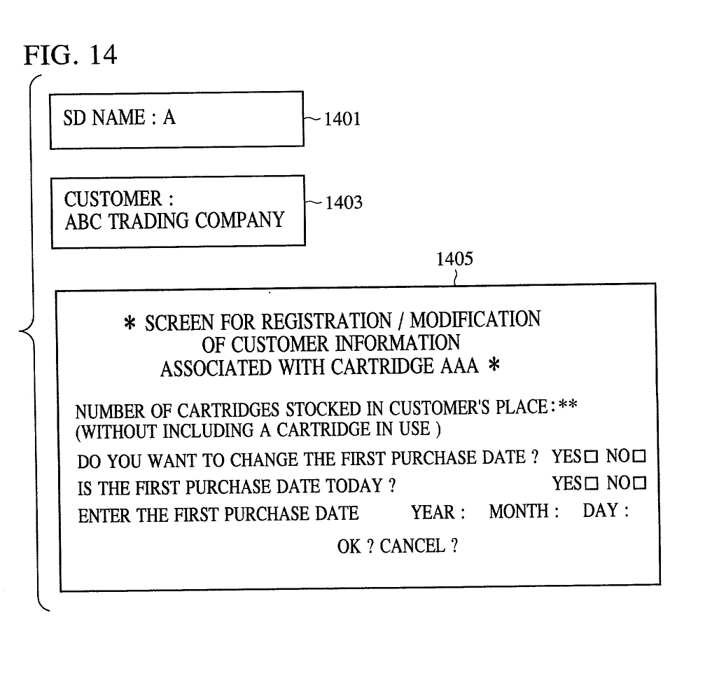

That is, when the customer list is displayed on the handy terminal as shown in FIGS. 7 or 8, or when detailed customer information is displayed as shown in FIGS. 9 or 10, if a “Customer Information Change” button or a “Customer Information Registration” button displayed on the handy terminal is clicked, a customer information registration/change screen is displayed on the handy terminal in accordance with data transmitted from the order reception management server, thereby making it possible to register or change customer information. FIG. 14 illustrates an example of a customer information registration/change screen displayed on the handy terminal in the article management system shown in FIG. 1.

As shown in FIG. 14, information displayed as the customer information registration/change screen on the handy terminal includes information about a sales driver name 1401, a customer name 1403, and customer information associated with cartridge AAA 1405. The customer information 1405 includes a box in which a number of articles stocked by the customer is entered, Yes/No buttons for specifying whether to change the first purchase date, Yes/No buttons for specifying whether the first purchase date is today, and boxes for entering the first purchase date. After inputting the above data, if the sales driver clicks an “OK” button, the input information is transmitted from the handy terminal to the order reception management server. Upon receiving the information from the handy terminal, the order reception management server registers or changes the customer information described in the database in accordance with the received information.

As described above, in the mail information confirmation/transmission operation according to the present embodiment, the sales driver can quickly acquire precise customer information in terms of, for example, an expendable article and can transmit a mail to a customer. The mail information confirmation/transmission operation can be performed in a more effective fashion as described below.

In this regard, a sales driver logs on to the order reception management server at the beginning of a job every morning using his/her SD ID. The order reception management server transmits a list of customer data to the handy terminal of the sales driver. The number of articles in stock, the previous purchase date, and the predicted next purchase date (predicted by the server) for each customer are displayed on the handy terminal in the order of dates closer to the present day. It is more desirable that customer names whose predicted next purchase date is within, for example two days after the present day be highlighted thereby informing the sales driver of the particular customers. If a button disposed in front of a customer name displayed on the handy terminal is clicked, information about that customer is displayed. Information indicating whether there is any article that should be delivered on the present day may also be displayed on the handy terminal. For example, marks “◯” and “x” may be used for this purpose. A list of customers to which articles should be delivered on the present day may also be displayed on the handy terminal. The handy terminal (HT) may also have a capability of receiving a list when it is needed.

As described earlier, it is also possible to transmit a mail to a customer by clicking a mail transmission button displayed on the handy terminal, thereby providing necessary information to the customer. This makes it possible to perform a sales activity in a more effective manner.

Sales

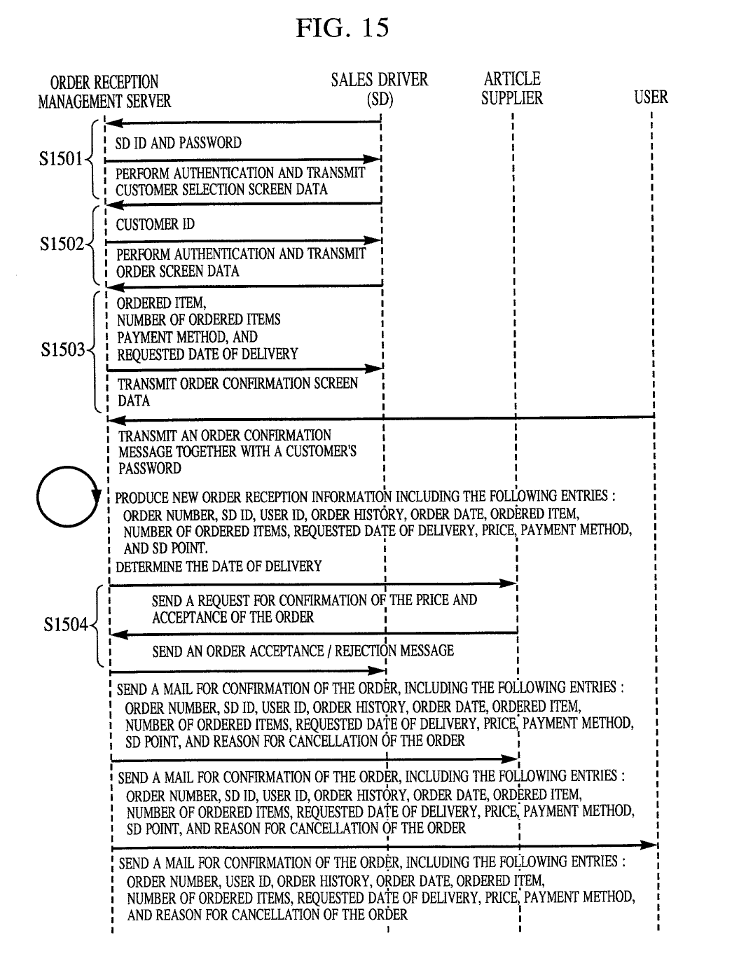

An operation performed by a sales driver, in the article management system shown in FIG. 1, to sell an article to a customer is described below with reference to FIGS. 15 to 17.

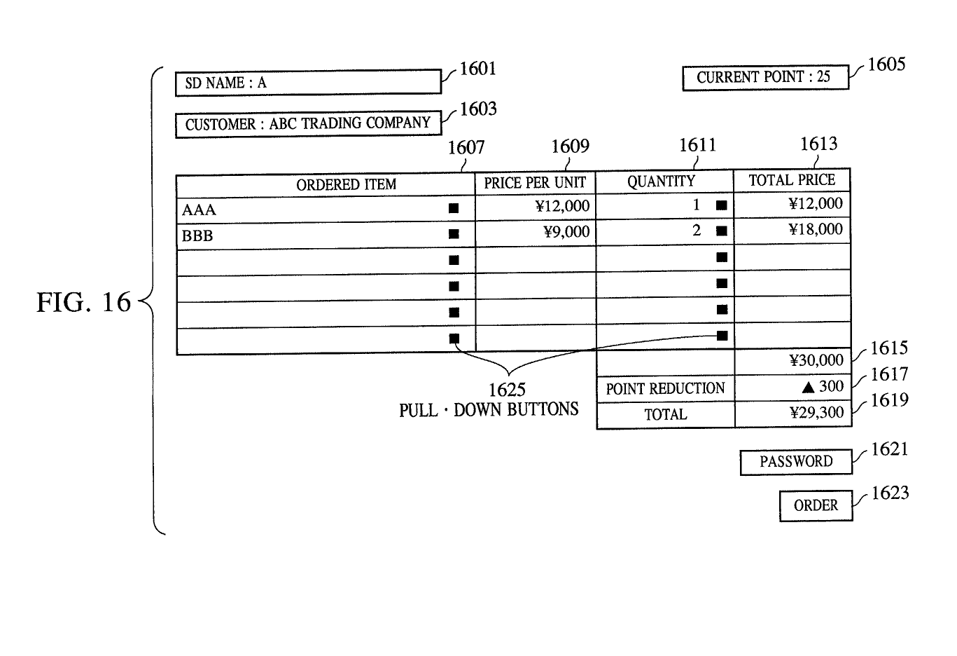

FIG. 15 is a flow chart illustrating an article sales operation performed in the article management system shown in FIG. 1. As shown in FIG. 15, the sales driver first inputs his SD ID and password via the handy terminal. In response, data indicating a customer selection screen is received from the order reception management server (step S1501). A customer ID is then transmitted from the handy terminal to the order reception management server. In response, order screen data is transmitted from the order reception management server to the handy terminal (step S1502). The sales driver then inputs an ordered item (name of an ordered article), the number of ordered articles, a payment method, a requested date of delivery via the order screen displayed on the handy terminal. The input information is transmitted to the order reception management server. Upon receiving the information from the handy terminal, the order reception management server transmits order confirmation screen data to the handy terminal of the sales driver (step S1503). The order confirmation screen data transmitted from the order reception management server to the handy terminal of the sales driver is described below with reference to FIG. 16. FIG. 16 illustrates an example of an order confirmation screen displayed on the handy terminal of the sales driver in accordance with data transmitted to the handy terminal from the order reception management server during a sales operation in the article management system shown in FIG. 1.

As shown in FIG. 16, information displayed as the order confirmation screen on the handy terminal of the sales driver includes a sales driver name 1601, a customer name 1603, and a current point 1605. The current point 1605 is managed by the order reception management server 101. On the basis of the current point 1605, an incentive is given to one or both of the customer and the sales driver. The value of the current point 1605 is increased when an article is purchased or collected. Thus, the current point 1605 serves as a sales point or a collection point according to the present invention. More specifically, the current point 1605 is updated by the order reception management server 101 depending upon the number of times that a purchase order (collection request) was received, the type of the ordered (collected) article, or the number of ordered (collected) articles or an arbitrary combination thereof.

In the present embodiment, an incentive is given to the customer and the sales driver on the basis of the same current point 1605. Alternatively, current points may be set separately for the customer and the sales driver. That is, current points 1605 may be set separately for the customer and the sales driver, and they may be changed independently in response to selling or collection of an article. In the case where the current point 1605 is set in common for the customer and the sales driver, the current point 1605 is set for each combination of a customer and a sales driver. In the case where the current points 1605 are separately set for a customer and a sales driver, and the current points are independently changed in response to selling or collection of an article, the current point 1605 is set for each customer and for each sales driver.

As shown in FIG. 16, a list of ordered items is displayed on the handy terminal. The list includes entries associated with an ordered item name 1607, an unit price 1609, the number of ordered items 1611, a total price 1613, a subtotal 1615, a point reduction 1617, and the grand total 1619. A pull-down button 1625 is disposed in each field in the ordered item column and the price column. If a pull-down button 1625 is clicked, detailed information of the clicked item is displayed. More specifically, for example, the capacity of an article is displayed. The point reduction is determined depending upon the current point 1605.

A “password” button 1621 and an “order” button 1623 are also displayed on the handy terminal. If the “password” button 1621 is clicked, the screen shown in FIG. 16 is switched to a password input screen. After the sales driver has completed the order reception operation including inputting the name of an article and other information, the customer inputs his password via the password input screen. After inputting the password, if the “order” button 1623 is clicked, an order request is transmitted to the order reception server. The displayed price for each item may be a selling price or a regular price.

As shown in the flow chart of FIG. 15, if the order reception management server receives the order confirmation message and the customer password, the order reception management server produces new order reception information. The new order reception information includes, for example, information about an order number, a SD ID, a customer ID, an order history, an order date, the item of ordered articles, the number of ordered articles, a requested date of delivery, a price, a payment method, a SD point, and a scheduled delivery date.

After completion of producing the new order reception information, the order reception management server transmits a price-confirmation/order-acceptance request to an article supplier server that is a server of an article supplier. In response to receiving the price-confirmation/order-acceptance request, the article supplier server transmits order acceptance/rejection information to the order reception management server (step S1504).

Finally, order reception management server transmits, to the handy terminal of the sales driver and the article supplier server, the order number, the SD ID, the customer ID, the order history, the order date, the item of ordered articles, the number of ordered articles, the requested date of delivery, the price, the payment method, the SD point, and a reason for cancellation of the collection (only when the collection is cancelled). The order reception management server also transmits, to the client device of the customer, the order number, the customer ID, the order history, the order date, the item of ordered articles, the number of ordered articles, the requested date of delivery, the price, a payment method, and the reason for cancellation of the collection (only when the collection is cancelled).

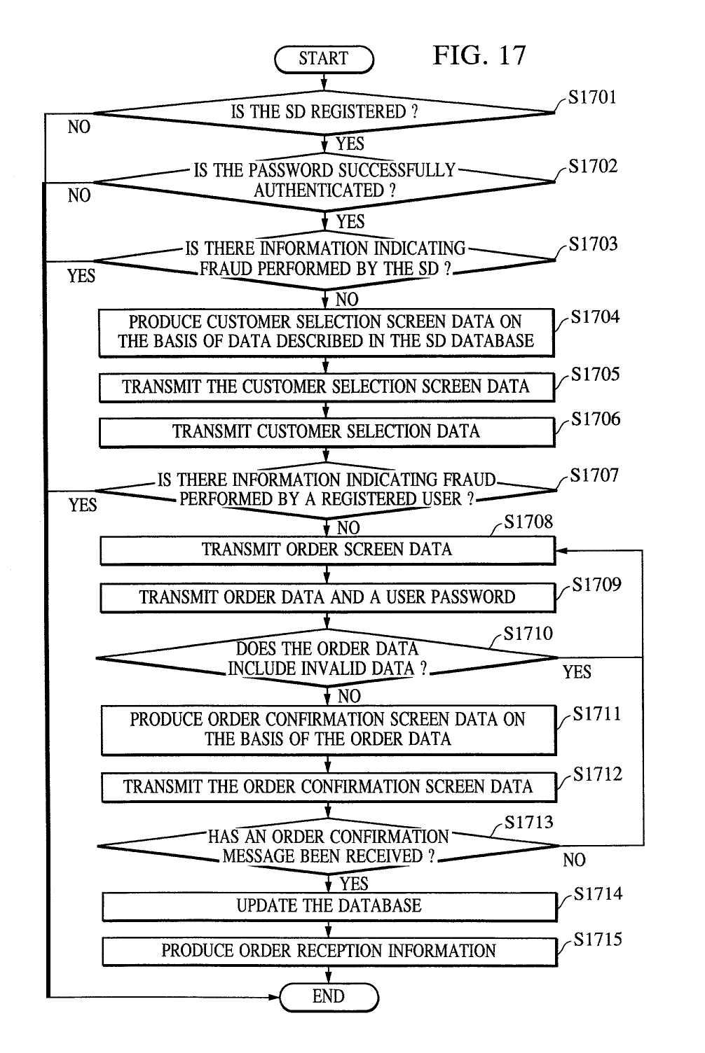

A sequence of steps of the sales operation is described below with reference to FIG. 17. FIG. 17 is a flow chart illustrating the sequence of steps of the sales operation performed in the article management system shown in FIG. 1.

First, in step S1701, the order reception management server determines whether the sales driver is an authorized sales driver, on the basis of the received SD ID. If the sales driver is an authorized sales driver, the process proceeds to step S1702. However, if the sales driver is not an authorized sales driver, the process is terminated.

In step S1702, the order reception management server authenticates the password on the basis of the received SD ID and the received password. If the authentication is successfully passed, the process proceeds to step S1703. However, in the case where the authentication fails, the process is terminated.

In step S1703, the order reception management server determines whether there is information indicating fraud performed by the authorized sales driver. If there is no such information, the process proceeds to step S1704. However, in the case where fraud is detected, the process is terminated.

In step S1704, the order reception management server produces customer selection screen data for selecting particular customers from those registered in the database on the basis of a sales driver ID. Then, in step S1705, the order reception management server transmits the customer selection screen data to the handy terminal of the sales driver, and in step S1706, the handy terminal transmits customer selection data indicating a selected customer to the order reception management server.

In step S1707, the order reception management server determines whether there is information indicating fraud performed by the authorized customer. If no fraud is detected, the process proceeds to step S1708. However, in the case where fraud is detected, the process is terminated.

In step S1708, the order reception management server transmits order screen data similar to that shown in FIG. 16 to the handy terminal, and in step S1709, the handy terminal transmits order data and a password (customer password) to the order reception management server. If the order reception management server receives the order data and the password (customer password), then in step S1710 the order reception management server determines whether the order data includes invalid data. If invalid data is detected, the process jumps to step S1708 to re-transmit the order screen data. In the case where no invalid data is detected, the process proceeds to step S1711.

In step S1711, the order reception management server produces order confirmation screen data on the basis of the received order data. In step S1712, the order reception management server transmits the order confirmation screen data to the client device and the handy terminal. This process step corresponds to issuing of an order confirmation mail shown in FIG. 15. The order reception management server then determines whether order confirmation data has been received by the client device and the handy terminal. If the order confirmation data has been received, the process proceeds to step S1714. However, if the order confirmation data has not been received, the process returns to step S1708.

The order reception management server updates the database in step S1714 and then produces order reception information in step S1715. Thereafter, the process ends.

As described above, the sales operation performed by the order reception management server allows the sales driver carrying the handy terminal to acquire information about the status of a customer in terms of an article stocked by the customer, thereby allowing the sales driver to sell the article depending upon the status. This results in promotion of sales.

As a greater number of articles are purchased or returned by a customer, the customer point increases and thus a greater rebate or the like is given to the customer. This causes the customer to have a strong incentive to purchase and return articles. The point may also be used as a base according to which an incentive given to the sales driver is determined. That is, as a sales driver sells or collects a greater number of articles, the point of the sales driver increases and thus the sales driver obtains a greater incentive. The incentive given to the sales driver may be, for example, a bonus, an increase in salary, and an extra allowance.

Stock Management

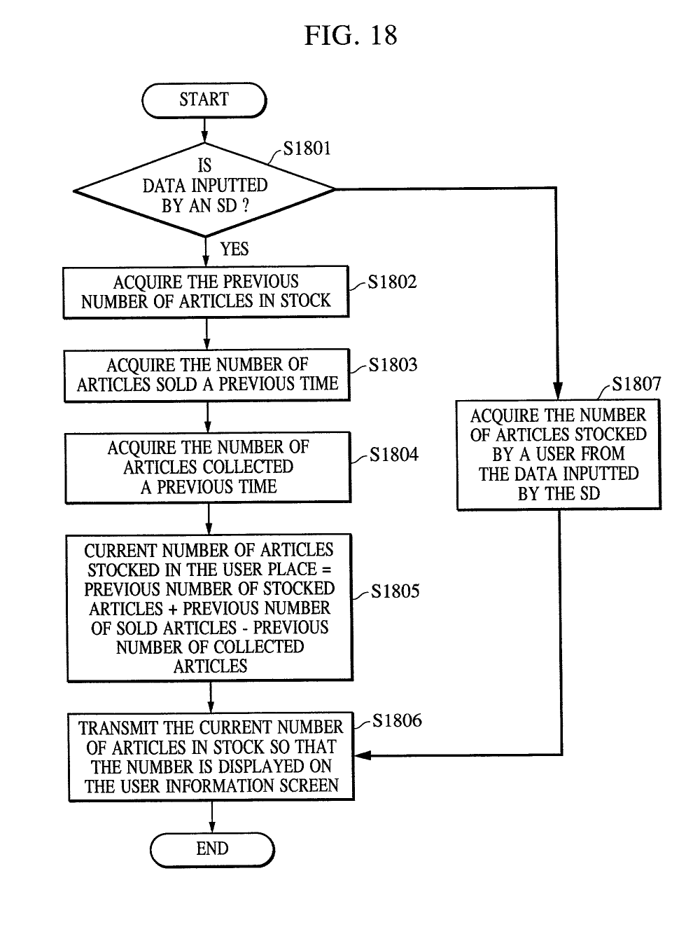

A stock management operation performed by the order reception management server is described below. As described above, a sales driver determines whether to sell articles to a customer (user) depending on the current number of articles stocked by the customer. To this end, the order reception management server manages the numbers of articles stocked by respective customers as described below with reference to FIG. 18 illustrating a flow of the stock management operation performed in the article management system shown in FIG. 1. To manage the number of articles in stock, the order reception management server determines, in step S1801 in FIG. 18, whether information associated with the number of articles in stock is inputted (transmitted) by a sales driver. If it is determined that information has been received from the sales driver, the process proceeds to step S1807. In step S1807, the order reception management server determines the number of articles stocked by the customer on the basis of the data received from the sales driver. Thereafter, the process proceeds to step S1806. On the other hand, in the case where no information is received from the sales driver, the process proceeds to step S1802.

In step S1802, the order reception management server acquires the previous number of articles stocked by the customer. Herein, the “previous” number of stocked articles refers to the number of articles determined by the calculation immediately previous to the present calculation (hereinafter, “previous” or “previously” will be used in a similar sense). The previous number of articles stocked by the customer is described in the database stored in the order reception management server.

In step S1803, the order reception management server acquires the previous number of sold articles. This number is also described in the database stored in the order reception management server. Herein, the previous number of sold articles refers to the number of articles that were sold to the customer during the period from the time at which the previous number of stocked articles was determined to the present time at which the present number of stocked articles is to be determined.

In step S1804, the order reception management server acquires the previous number of collected articles. Herein, the previous number of collected articles refers to the number of articles that were collected during a period from the time at which the previous number of stocked articles was determined to the present time.

In step S1805, the order reception management server determines the current number of articles stocked by the customer by subtracting the previous number of collected articles from the sum of the previous number of stocked articles and the previous number of sold articles.

In step S1806, the order reception management server stores the calculated current number of articles stocked by the customer into the database and transmits customer information indicating the current number of articles stocked by the customer to the handy terminal of the sales driver. The calculated current number of stocked articles is displayed on the screen of the handy terminal as the predicted number of articles stocked by the customer 709 or 721 as shown in FIGS. 7 or 8.

In the present embodiment, the order reception management server predicts and manages the current number of articles stocked by the customer by means of performing the above-described calculation, and the order reception management server sends resultant information to the sales driver.

Collection of Articles

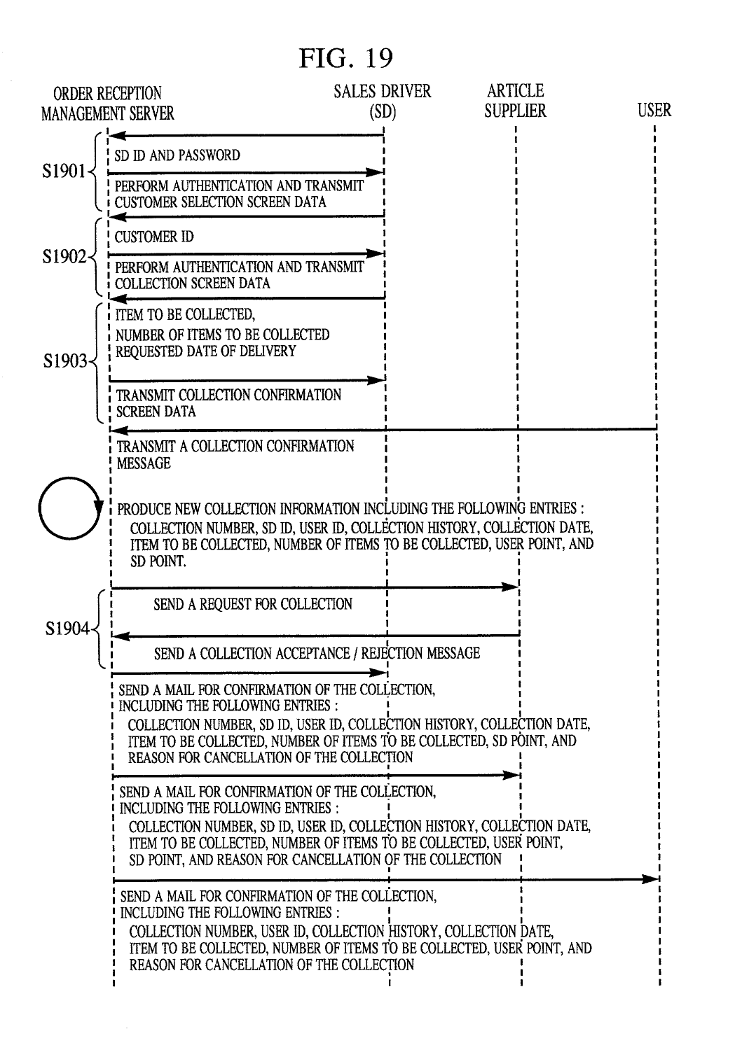

A collection operation performed in the article management system according to an embodiment of the present invention is described below with reference to FIGS. 19 to 22. FIG. 19 is a flow chart showing the collection operation performed in the article management system shown in FIG. 1. In the collection operation according to the present embodiment, articles such as used toner cartridges are collected.

First, as shown in FIG. 19, the sales driver inputs his/her SD ID and password via the handy terminal. In response, a customer selection screen is displayed in accordance with data transmitted from the order reception management server (step S1901). This access to the order reception management server is performed as a “request to the server” that is one process step according to the present invention. Thereafter, the handy terminal transmits a customer ID to the order reception management server, as a “request to the server” that is one process step according to the present invention. In response to receiving the customer ID, the order reception management server transmits collection screen data to the handy terminal (step S1902). As a result, the predicted number of articles that should be collected from each customer is displayed on the screen of the handy terminal in accordance with the data transmitted from the order reception management server. In accordance with the prediction made by the order reception management server, the sales driver carrying the handy terminal collects articles.

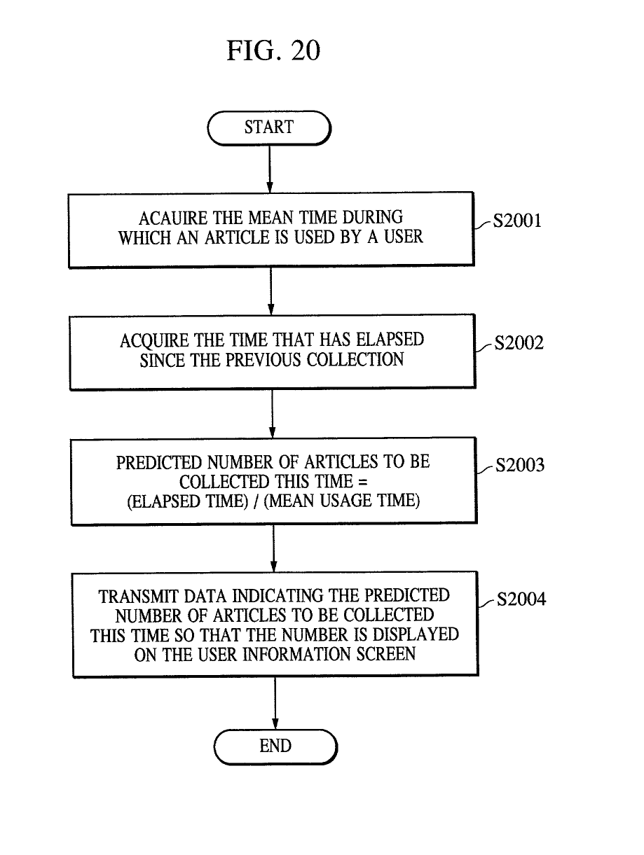

The operation of determining the predicted number of articles to be collected is described below with reference to FIG. 20. FIG. 20 is a flow chart illustrating the operation performed by the order reception management server of the article management system shown in FIG. 1 to determine the predicted number of articles collected from a customer.

As shown in FIG. 20, in step S2001, the order reception management server determines the mean usage time during which an article is used by a customer. This mean usage time (t) is calculated by the order reception management server, for example, by dividing a particular period (T) by the number of articles (X) sold to each customer during the period (T). That is, the mean usage time (t) is given by the following equation:

Mean Usage Time (t)=Period (T)/Number of articles (X) sold to each customer

Thereafter, the order reception management server determines the time that has elapsed from the previous time at which articles were collected to the present time (step S2002).

In step S2003, the order reception management server determines the predicted number of articles to be collected this time, by dividing the elapsed time from the previous collection time calculated in step S2002 by the mean usage time calculated in step S2001. Depending on values, the quotient obtained by dividing the elapsed time from the previous collection time by the mean usage time calculated in step S2001 cannot be equal to an integer. In such a case, the largest integer smaller than the quotient or the smallest integer greater than the quotient is employed as the predicted number of articles to be collected this time.

In step S2004, the order reception management server transmits data indicating the predicted number of articles to be collected so that it is displayed on the customer information screen. The method of calculating the predicted number of articles to be collected is not limited to that described above. In the article management system according to the present invention, the predicted number of articles to be collected may also be determined by another method or in accordance with another equation.

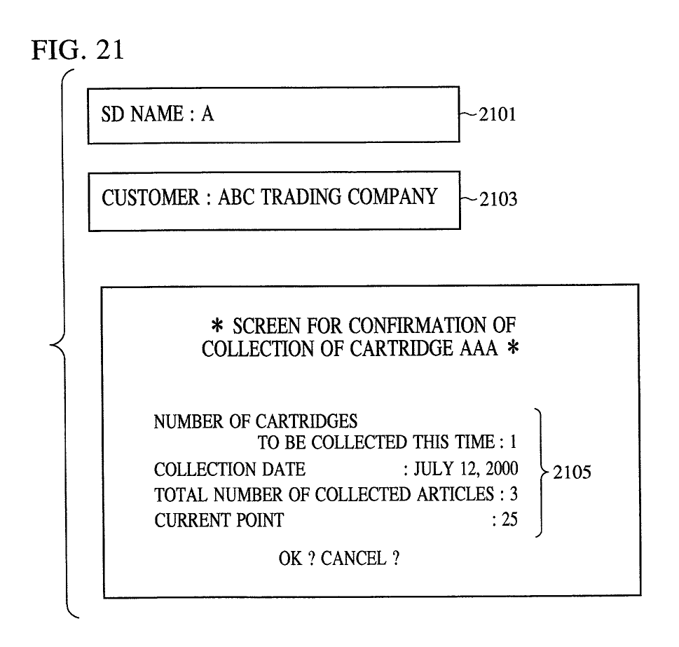

Referring again to the flow chart of FIG. 19, the sales driver inputs an item (article) to be collected and the number of articles to be collected via the collection screen displayed on the handy terminal. The input data is transmitted to the order reception management server. In response to receiving the data, the order reception management server transmits collection confirmation screen data to the handy terminal of the sales driver (step S1903). The collection confirmation screen data transmitted to the handy terminal of the sales driver from the order reception management server is described below with reference to FIG. 21. FIG. 21 shows an example of a collection confirmation screen displayed on the handy terminal of the sales driver in accordance with data transmitted from the order reception management server, in the collection operation performed by the article management system shown in FIG. 1.

As shown in FIG. 21, a sales driver name 2101, a customer name 2103, and collection information 2105 are displayed on the handy terminal of the sales driver. The collection information 2105 includes information about the number of articles to be collected this time, a collection date, the total number of collected articles, and a current point. The current point is a collection point that is used in the present invention as a base according to which an incentive is given to a customer. The current point is determined depending on the number of times that articles were purchased or collected.

To collect articles, a collection request is transmitted from the handy terminal to the order reception management server. In general, collection of an article is performed in response to a request issued by a customer. In the case of collection of an article, unlike the sales of an article, inputting of a password is not necessarily required.

As shown in the flow chart of FIG. 19, if the order reception management server receives data indicating approval of the collection, the order reception management server produces new collection information. The new collection information includes information about a collection number, a SD ID, a customer ID, a collection history, a collection date, an item to be collected, the number of articles to be collected, a customer point (collection point), a SD point (collection point), and a scheduled collection date. After producing the new collection information, the order reception management server transmits a collection approval request to an article supplier server that is a server of an article supplier. In response to receiving the collection approval request, the article supplier server transmits a collection approval/rejection message to the order reception management server (step S1904).

Finally, the order reception management server transmits, to the handy terminal of the sales driver, data indicating the collection number, the SD ID, the customer ID, the collection history, the collection date, the item of articles to be collected, the number of articles to be collected, the SD point, and a reason for cancellation of the collection (only when the collection is cancelled). Furthermore, the order reception management server transmits, to the article supplier server, data indicating the collection number, the SD ID, the customer ID, the collection history, the collection date, the item to be collected, the number of articles to be collected, the customer point, the SD point, the reason for cancellation of the collection (only when the collection is cancelled). The order reception management server also transmits, to the client device of the customer, data indicating the collection number, the customer ID, the collection history, the collection date, the item to be collected, the number of articles to be collected, the customer point, the reason for cancellation of the collection (only when the collection is cancelled).

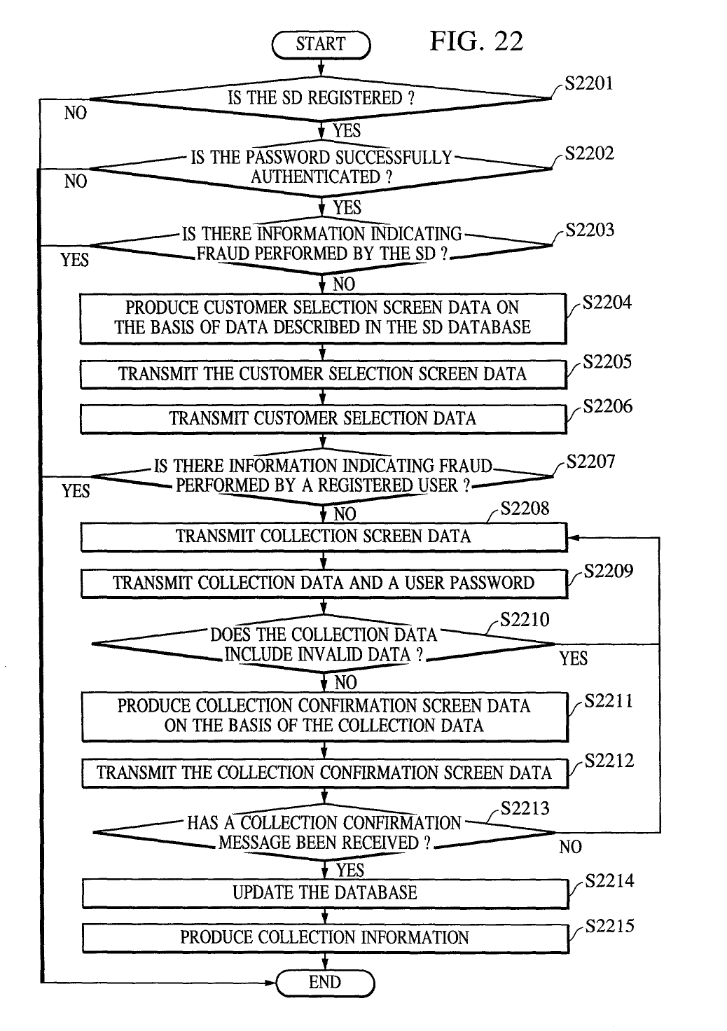

A sequence of the sales operation is described below with reference to FIG. 22. FIG. 22 is a flow chart illustrating the sequence of the sales operation performed in the article management system shown in FIG. 1.

First, in step S2201, the order reception management server determines, on the basis of the received SD ID, whether the sales driver is an authorized sales driver. If the sales driver is an authorized sales driver, the process proceeds to step S2202. However, if the sales driver is not an authorized sales driver, the process is terminated.

In step S2202, the order reception management server authenticates the password on the basis of the received SD ID and password. If the authentication has been successfully passed, the process proceeds to step S2203. However, if the authentication fails, the process is terminated.

In step S2203, the order reception management server determines whether there is information indicating fraud performed by the authorized sales driver. If no fraud is detected, the process proceeds to step S2204. However, if fraud is detected, the process is terminated.

In step S2204, the order reception management server produces customer selection screen data for selecting particular customers from those registered in the database on the basis of the sales driver ID, and in step S2205, the order reception management server transmits the customer selection screen data to the handy terminal of the sales driver. Then, in step S2206, the handy terminal transmits customer selection data indicating a selected customer to the order reception management server. The order reception management server determines whether there is information indicating fraud performed by the selected customer (step S2207). If no fraud is detected, the process proceeds to step S2208. However, if fraud is detected, the process is terminated.

In step S2208, the order reception management server transmits collection screen data to the handy terminal. Information displayed on the collection screen includes information indicating the predicted number of articles to be collected from the customer, which was described above with reference to FIG. 20.

In step S2209, the handy terminals transmits to the order reception management server the collection data and also the password (customer password) if necessary. If the order reception management server receives the collection data and the password (customer password), then the order reception management server determines, in steps S2210, whether the collection data includes invalid data. If invalid data is detected, the process returns to step S2208 to re-transmit the collection screen data. If no invalid data is detected, the process proceeds to step S2211.

In step S2211, the order reception management server produces collection confirmation screen data on the basis of the collection data. In step S2212, the order reception management server transmits the collection confirmation screen data to the client device and the handy terminal. The collection confirmation screen may be similar to the screen shown in FIG. 21. The order reception management server determines whether the client device and the handy terminal have received the collection confirmation data. If the data has been received, the process proceeds to step S2214. However, if the data has not been received, the process returns to step S2208. The order reception management server updates the database in step S2214 and produces collection information in step S2215. Thereafter, the process ends.

As described above, the collection operation performed by the order reception management server allows the sales driver carrying the handy terminal to acquire information about the status of a customer in terms of an item stocked by the customer, thereby allowing the sales driver to collect an article depending upon the status.

This makes it unnecessary for a customer to make an additional contact to request collection of an article. The sales driver is allowed to collect articles from a customer when the sales driver visits the customer for delivery. This results in a reduction in job done by the sales driver.

If a large number of articles are purchased or collected, the customer point increases. This can be an incentive for the customer to purchase and return articles. The point may also be used as a base according to which an incentive given to the sales driver is determined. That is, as the sales driver sells a larger number of articles to customers or collects a larger number of articles, the point of the sales driver becomes higher, and thus the sales driver can obtain a greater benefit such as a greater bonus. As described earlier, the point may be determined separately for the customer and the sales driver. The incentive given to the sales driver may be, for example, a bonus, an increase in salary, or an extra allowance.

Incentive Management

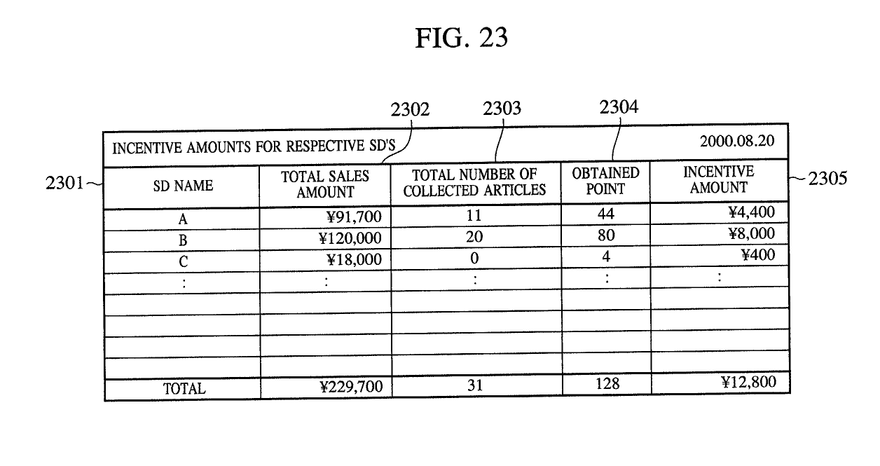

Management of incentive information for each sales driver performed by the order reception management server 101 shown in FIG. 1 is described below with reference to FIG. 23. FIG. 23 illustrates an example of incentive information associated with each sales driver, managed by the order reception management server 101 shown in FIG. 1.

As shown in FIG. 23, the incentive information described in the database includes information about a sales driver name 2301, the total sales amount for each sales driver 2302, the total number of collected articles for each sales driver 2303, an obtained point for each sales driver 2304, and an incentive value for each sales driver 2305. The sum of the total sales amounts of respective sales drivers, the sum of the total numbers of articles collected by respective sales drivers, the sum of the obtained points for respective sales drivers, and the sum of the incentive values for respective sales drivers are calculated and described in the database. More specifically, the order reception management server 101 calculates the point 2304 for each sales driver on the basis of the total sales amount 2302 and the total number of collected articles 2303 and further calculates the incentive value 2305 for the sales driver from the calculated point 2304. The calculated result is stored in the database shown in FIG. 23.

In the example shown in FIG. 23, data such as incentive value data 2305 for all sales drivers are shown. However, in the case where a sales driver accesses the order reception management server 101 via his/her handy terminal 111, the order reception management server 101 identifies the sales driver on the basis of the sales driver ID and the order reception management server 101 transmits only incentive information associated with that sales driver to his/her handy terminal 111. The order reception management server 101 produces and manages incentive information for each sales driver such as that shown in FIG. 23.

Although in the embodiments described above, a handy terminal is employed as a terminal that is one part in the present invention, the terminal used in the invention is not limited to such a type of terminal and another type of terminal may also be employed. For example, a portable terminal such as a portable telephone, a PDA (personal digital assistant), a mobile personal computer may be employed.

In the above-described embodiments of the present invention, it is assumed that a toner cartridge is sold and collected as an article. However, in the article management system according to the present invention, the article is not limited to the toner cartridge, but other types of articles such as a photosensitive drum, a developer, or ink may be sold and collected. Any combination of such articles may also be sold and collected in the article management system according to the present invention.

In an article management system according to an embodiment of the present invention, as described above, information about the number of articles stocked by respective customers is stored in an order reception management server 101, and the information is transmitted to a handy terminal 111 of a sales driver. The sales driver sells an article such as a toner cartridge in accordance with information displayed on the handy terminal 111. The sales point is increased depending on the sales performance of a sales driver. Depending on the sales point, an incentive such as a rebate or a bonus is given to a customer or a sales driver. This results in sales promotion.

The numbers of articles stocked by customers are managed by the order reception management server 101 so as to prevent a lack of stock. The order reception management server 101 predicts the number of articles to be collected from a customer. The sales driver is informed of the predicted number of articles to be collected via the handy terminal 111. In accordance with the given information about the predicted number of articles to be collected, the sales driver collects articles from the customer. This allows the sales driver to obtain information indicating when collection of articles from customer should be performed. Thus, the sales driver can collect articles in an efficient manner. When a sales driver collects an article, a collection point similar to a sales point is given to the sales driver. The total collection point is stored in the order reception management server 101, and an incentive is given to the sales driver depending upon the collection point. This results in promotion of collection of articles.

In the article management system according to the embodiment of the preset invention, as described above, entire information about sales and collection of articles is stored in the order reception management server 101, and a necessary part of information is transmitted to a handy terminal 111 of a sales driver so that the sales driver can sell and collect articles in an efficient fashion in accordance with the given information. This allows a reduction in cost needed in sales and collection of articles.

In the article management system according to the embodiment of the present invention, as described above, sales promotion is performed by a deliverer. This means that a seller can achieve sales promotion without needing an additional person for sales promotion. Besides, sales promotion can be achieved via a deliverer even for a customer to whom a sales person of a seller is not allowed to visit. A deliverer can obtain a benefit via an activity for sales promotion. A customer can easily obtain an article by ordering it not via a telephone or a facsimile but via a deliverer.

In the present invention, as described above, information about the number of articles stocked by a customer and information about the number of articles to be collected from a customer are transmitted to a terminal of a deliverer, and the deliverer sells and collects articles in accordance with the given information. This ease a task performed by a customer to manage stock of articles and allows a seller to sell and collect articles in an efficient fashion. Furthermore, promotion of sales and collection of articles is achieved.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A management system comprising
order reception means for receiving an order from a terminal of a deliverer who delivers an article to a customer; and
management means for managing an incentive given to the deliverer in accordance with an order received via the order reception means.

2. A management system according to claim 1, wherein the managing incentive includes updating a point, on a basis of which the incentive is given, in response to an article order reception message or an article collection message transmitted from the terminal of the deliverer.

3. A management system according to claim 1, wherein the order reception means performs an order reception process including a process of receiving confirmation from a customer.

4. A management system according to claim 1, wherein the article comprises an expendable article, and wherein the management system further comprises information output means for displaying a screen on which information indicating a predicted time at which the expendable article will be purchased by a customer is displayed.

5. A management system according to claim 4, wherein the screen displayed by the information output means includes information indicating a customer who is expected, with a high probability, to purchase an article on a particular date.

6. A management system according to claim 4, wherein the information output means displays a list of customers to whom articles should be delivered on a particular date, and wherein the list includes information indicating a predicted time at which an article will be purchased by a customer.

7. A management system according to claim 1, further comprising notification means for, before delivering an article to a customer by a deliverer, sending a message to the customer to prompt the customer to order the article.

8. A management system according to claim 7, wherein the notification means simultaneously sends a message to all customers retrieved according to a predetermined retrieval condition, in response to a single command.

9. A management system according to claim 1, wherein the article comprises at least one of a photosensitive unit, a developer, a toner cartridge, or ink.

10. A management method comprising the steps of:
receiving an order from a terminal of a deliverer who delivers an article to a customer; and
managing an incentive given to the deliverer in accordance with an order received in the receiving step.

11. A management method according to claim 10, wherein the managing step includes updating a point, on a basis of which the incentive is given, in response to an article order reception message or an article collection message transmitted from the terminal of the deliverer.

12. A management method according to claim 10, wherein the receiving step includes receiving confirmation from a customer.

13. A management method according to claim 10, wherein the article comprises an expendable article, and wherein the management method further comprises the step of outputting information such that information indicating a predicted time at which the expendable article will be purchased by a customer is displayed on a screen.

14. A management method according to claim 13, wherein the outputting step comprises displaying information indicating a customer who is expected, with a high probability, to purchase an article on a particular date.

15. A management method according to claim 13, wherein the outputting step comprises displaying a list of customers to whom articles should be delivered on a particular date, the list including information indicating a predicted time at which an article will be purchased by a customer.

16. A management method according to claim 10, further comprising the step of, before delivering an article to a customer, sending a message to the customer to prompt the customer to order the article.

17. A management method according to claim 10, further comprising the step of simultaneously sending a message to all customers retrieved according to a predetermined retrieval condition, in response to a single command.

18. A management method according to claim 10, wherein the article comprises at least one of a photosensitive unit, a developer, a toner cartridge, or ink.

19. A management program comprising the steps of:
receiving an order from a terminal of a deliverer who delivers an article to a customer; and
managing an incentive given to the deliverer in accordance with an order received in the receiving step.

20. A management program according to claim 19, wherein the managing step includes updating a point, on a basis of which the incentive is given, in response to an article order reception message or an article collection message transmitted from the terminal of the deliverer.

21. A management program according to claim 19, wherein the receiving step includes receiving confirmation from a customer.

22. A management program according to claim 19, wherein the article comprises an expendable article, and wherein the management program further comprises the step of outputting information such that information indicating a predicted time at which the expendable article will be purchased by a customer is displayed on a screen.

23. A management program according to claim 22, wherein the outputting step comprises displaying information indicating a customer who is expected, with a high probability, to purchase an article on a particular date.

24. A management program according to claim 22, wherein the outputting step comprises displaying a list of customers to whom articles should be delivered on a particular date, the list including information indicating a predicted time at which an article will be purchased by a customer.

25. A management program according to claim 19, further comprising the step of, before delivering an article to a customer by a deliverer, sending a message to the customer to prompt the customer to order the article.

26. A management program according to claim 25, wherein the message sending step is adapted to send a message to all customers retrieved according to a predetermined retrieval condition, in response to a single command.

27. A management program according to claim 19, wherein the article comprises at least one of a photosensitive unit, a developer, a toner cartridge, or ink.

28. A computer-readable storage medium on which a management program is stored, the management program comprising the steps of:
receiving an order from a terminal of a deliverer who delivers an article to a customer; and
managing an incentive given to the deliverer in accordance with an order received in the receiving step.

29. A computer-readable storage medium according to claim 28, wherein the managing step comprises updating a point, on a basis of which the incentive is given, in response to an article order reception message or an article collection message transmitted from the terminal of the deliverer.

30. A computer-readable storage medium according to claim 28, wherein the receiving step comprises receiving confirmation from a customer.

31. A computer-readable storage medium according to claim 28, wherein the article comprises an expendable article, and wherein the management method further comprises the step of outputting information such that information indicating a predicted time at which the expendable article will be purchased by a customer is displayed on a screen.

32. A computer-readable storage medium according to claim 31, wherein the outputting step comprises displaying information indicating a customer who is expected, with a high probability, to purchase an article on a particular date.

33. A computer-readable storage medium according to claim 31, wherein the outputting step comprises displaying a list of customers to whom articles should be delivered on a particular date, the list including information indicating a predicted time at which an article will be purchased by a customer.

34. A computer-readable storage medium according to claim 28, wherein the management program further comprises the step of, before delivering an article to a customer by a deliverer, sending a message to the customer to prompt the customer to order the article.

35. A computer-readable storage medium according to claim 34, wherein the message sending step is adapted to send a message to all customers retrieved according to a predetermined retrieval condition, in response to a single command.

36. A computer-readable storage medium according to claim 28, wherein the article comprises at least one of a photosensitive unit, a developer, a toner cartridge, or ink.
